(19) United States
(12) Patent Application Publication
(10) Pub. No.: US 2026/0235774 A1
(43) Pub. Date: Aug. 13, 2026

(54) Sensor Module

(71) Applicant: SEIKO EPSON CORPORATION, Tokyo (JP)

(72) Inventor: Fumiya ITO, Minowa (JP)

(21) Appl. No.: 19/538,082

(22) Filed: Feb. 12, 2026

(30) Foreign Application Priority Data
Feb. 13, 2025 (JP) 2025-021358

(51) Int. Cl. G01S 19/47; G01P 3/44; G01P 15/125; G01P 15/18

(52) U.S. Cl. CPC G01S 19/47; G01P 3/44; G01P 15/125; G01P 15/18

(57) ABSTRACT

A sensor module includes a first angular velocity sensor configured to detect an angular velocity about the first axis to output a first angular velocity signal, to detect an angular velocity about the second axis to output a second angular velocity signal, and to detect an angular velocity about the third axis to output a third angular velocity signal, a second angular velocity sensor configured to detect an angular velocity about a fourth axis, and a correction circuit configured to correct an alignment error, which is an error of the angular velocity about the fourth axis due to deviation of the fourth axis with respect to the third axis, based on a sensitivity ratio of the angular velocity about the third axis and the first angular velocity signal, the second angular velocity signal, the third angular velocity signal, and the fourth angular velocity signal.

The present application is based on, and claims priority from JP Application Serial Number 2025-021358, filed Feb. 13, 2025, the disclosure of which is hereby incorporated by reference herein in its entirety.

### BACKGROUND

### 1. Technical Field

The present disclosure relates to a sensor module.

### 2. Related Art

JP-A-2019-158425 describes an inertial measurement device including an inertial sensor including a three-axis angular velocity sensor and a high-accuracy Z-axis angular velocity sensor.

When, as in the inertial measurement device described in JP-A-2019-158425, a high-accuracy Z-axis angular velocity sensor is provided separately from an inertial sensor including a three-axis angular velocity sensor, misalignment may occur between the three-axis angular velocity sensor and the Z-axis angular velocity sensor. Due to this misalignment, an error may occur in an angular velocity signal output from the Z-axis angular velocity sensor.

### SUMMARY

One aspect of a sensor module according to the present disclosure includes, when three axes orthogonal to each other are defined as a first axis, a second axis, and a third axis, a first angular velocity sensor configured to detect an angular velocity about the first axis to output a first angular velocity signal, to detect an angular velocity about the second axis to output a second angular velocity signal, and to detect an angular velocity about the third axis to output a third angular velocity signal, a second angular velocity sensor configured to detect an angular velocity about a fourth axis corresponding to the third axis to output a fourth angular velocity signal, and a correction circuit configured to correct an alignment error, which is an error of the angular velocity about the fourth axis due to deviation of the fourth axis with respect to the third axis, based on a sensitivity ratio of the angular velocity about the third axis and the first angular velocity signal, the second angular velocity signal, the third angular velocity signal, and the fourth angular velocity signal.

### BRIEF DESCRIPTION OF THE DRAWINGS

FIG. 1 is a diagram illustrating a configuration example of a self-position estimation system in which a sensor module of the present embodiment is incorporated.

FIG. 2 is an explanatory diagram of an X-axis, a Y-axis, and a Z-axis.

FIG. 3 is a diagram illustrating a configuration example of the sensor module of the present embodiment.

FIG. 4 is an explanatory view of misalignment.

FIG. 5 is an explanatory view of misalignment.

FIG. 6 is a calculation block diagram of a Kalman filter.

### DESCRIPTION OF EMBODIMENTS

Hereinafter, preferred embodiments of the present disclosure will be described in detail with reference to the drawings. The following embodiment does not inappropriately limit the contents of the present disclosure described in the claims. Furthermore, not all of the configurations described below are essential constituent elements of the present disclosure.

### 1. First Embodiment

### 1-1. Configuration of Integrated Navigation System

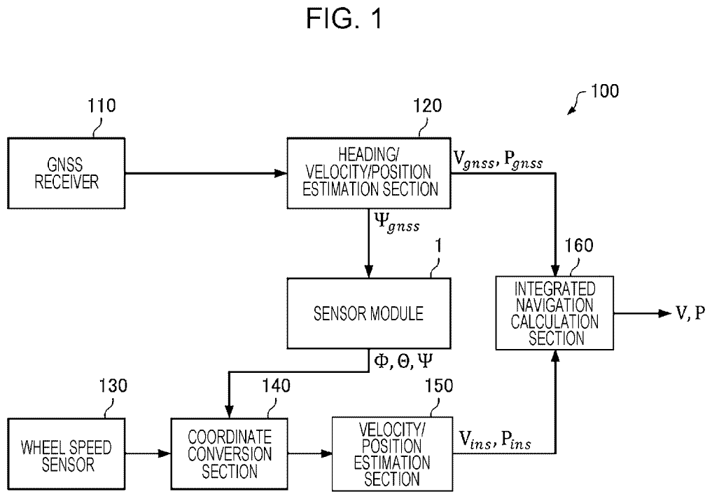

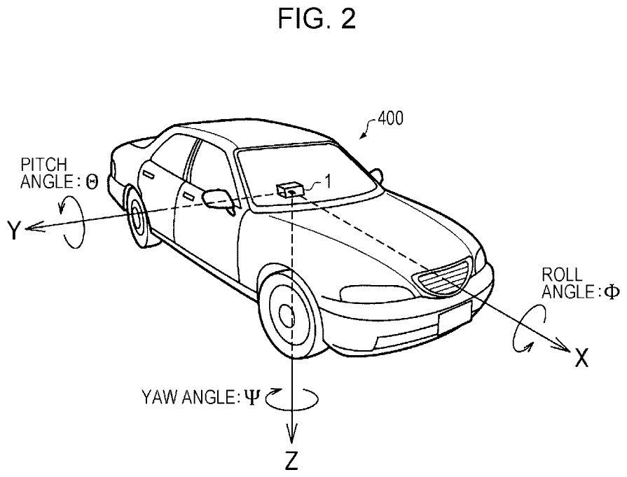

FIG. 1 is a diagram illustrating a configuration example of a self-position estimation system 100 in which a sensor module 1 of the present embodiment is incorporated. As illustrated in FIG. 1, the self-position estimation system 100 includes a sensor module 1, a GNSS receiver 110, a heading/velocity/position estimation section 120, a wheel speed sensor 130, a coordinate conversion section 140, a velocity/position estimation section 150, and an integrated navigation calculation section 160, and is mounted on, for example, an automobile 400 as illustrated in FIG. 2. In FIG. 2, each section other than the sensor module 1 of the self-position estimation system 100 is not illustrated.

The GNSS receiver 110 receives, via an antenna (not illustrated), satellite signals transmitted from a plurality of satellites constituting a part of a global navigation satellite system (GNSS), performs positioning based on the received satellite signals, and outputs positioning information. Examples of the GNSS include the global positioning system (GPS), the quasi zenith satellite system (QZSS), the european geostationary navigation overlay service (EGNOS), the global navigation satellite system (GLONASS), GALILEO, and BeiDou.

The heading/velocity/position estimation section 120 estimates the heading, velocity, and position of the automobile 400 based on the positioning information output from the GNSS receiver 110, and outputs a heading Ψ_{gnss}, a velocity V_{gnss}, and a position p_{gnss} in the NED coordinate system.

The sensor module 1 is an inertial sensor module that detects acceleration in three axial directions orthogonal to each other and angular velocity about the three axes. As illustrated in FIG. 2, for example, the sensor module 1 is mounted on the automobile 400 so that the three axes extend along an X-axis, a Y-axis, and a Z-axis orthogonal to each other. The X-axis is an-axis along a traveling direction of the automobile 400, the Y-axis is an-axis in a right direction orthogonal to the traveling direction of the automobile 400, and the Z-axis is an-axis along a downward direction perpendicular to a surface on which the automobile 400 travels.

The sensor module 1 calculates a roll angle Φ, a pitch angle Θ, and a yaw angle Ψ of the automobile 400 based on the detected accelerations and angular velocities in the three axial directions and the heading Ψ_{gnss} output from the heading/velocity/position estimation section 120, and outputs the calculated roll angle Φ, pitch angle Θ, and yaw angle Ψ to the outside. The roll angle Φ is a rotation angle with the X-axis as a rotation axis, the pitch angle Θ is a rotation angle with the Y-axis as a rotation axis, and the yaw angle Ψ is a rotation angle with the Z-axis as a rotation axis. The roll angle Φ and the pitch angle Θ represent an attitude of the automobile 400, and the yaw angle Ψ represents the relative heading of the automobile 400.

The wheel speed sensor 130 detects a rotation speed of a wheel of the automobile 400 and outputs a wheel speed signal.

The coordinate conversion section 140 converts the wheel speed signal output from the wheel speed sensor 130 into a signal of three-axis velocity in an NED coordinate system based on the roll angle Φ, the pitch angle Θ, and the yaw angle Ψ output from the sensor module 1.

The velocity/position estimation section 150 estimates the velocity and position of the automobile 400 based on the signal of the three-axis velocity output from the coordinate conversion section 140, and outputs a velocity Vᵢₙₛ and a position Pᵢₙₛ in the NED coordinate system.

The integrated navigation calculation section 160 performs an integrated navigation calculation process using the velocity V_{gns} and the position P_{gns} output from the heading/velocity/position estimation section 120 and the velocity Vᵢₙₛ and the position Pᵢₙₛ output from the velocity/position estimation section 150 to calculate a velocity V and a position P of the automobile 400.

The calculated velocity V and position P of the automobile 400 are used for, for example, autonomous driving (AD) or an advanced driver assistance system (ADAS).

The integrated navigation in the system of FIG. 1 is loose coupling in which the estimation results of the velocity and the position based on the GNSS and the estimation results of the velocity and the position based on the INS are integrated, but other integrated navigation includes tight coupling in which raw data based on the GNSS and the estimation result of the INS are integrated, deep coupling in which the estimation result of the INS is further fed back to the tracking of the GNSS, and the like.

### 1-2. Configuration of Sensor Module

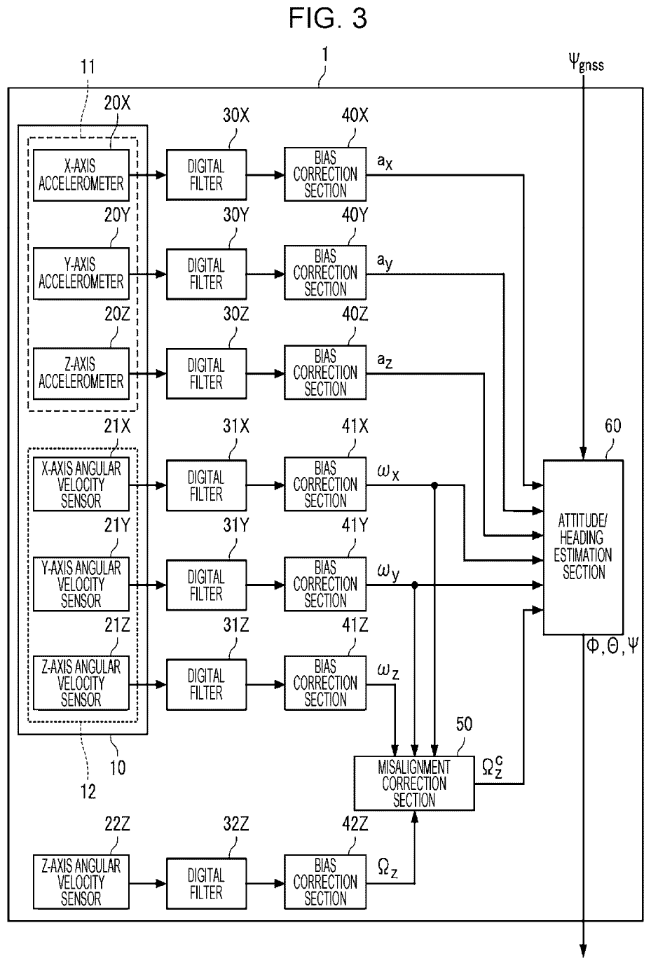

FIG. 3 is a diagram illustrating a configuration example of the sensor module 1. As illustrated in FIG. 3, the sensor module 1 includes a 6DoF sensor 10. DoF is an abbreviation for Degrees of Freedom. The 6DoF sensor 10 includes a three-axis accelerometer 11 and a three-axis angular velocity sensor 12, which are inertial sensors, respectively.

The three-axis accelerometer 11 includes an X-axis accelerometer 20X, a Y-axis accelerometer 20Y, and a Z-axis accelerometer 20Z.

The X-axis accelerometer 20X detects acceleration in an X-axis direction with the X-axis as a detection axis, and outputs an X-axis acceleration signal corresponding to the detected acceleration. The Y-axis accelerometer 20Y detects acceleration in a Y-axis direction with the Y-axis as a detection axis, and outputs a Y-axis acceleration signal corresponding to the detected acceleration. The Z-axis accelerometer 20Z detects acceleration in the Z-axis direction with the Z-axis as a detection axis, and outputs a Z-axis acceleration signal corresponding to the detected acceleration. For example, each of the X-axis accelerometer 20X, the Y-axis accelerometer 20Y, and the Z-axis accelerometer 20Z may be a capacitive MEMS accelerometer including sensor elements obtained by processing a silicon substrate by a MEMS technique. The MEMS is an abbreviation for Micro Electro Mechanical Systems.

For example, each of the X-axis accelerometer 20X, the Y-axis accelerometer 20Y, and the Z-axis accelerometer 20Z outputs a digital signal of a value corresponding to the acceleration detected at a constant sampling period Δt.

As described above, the three-axis accelerometer 11 detects acceleration in the X-axis direction and outputs an X-axis acceleration signal, detects acceleration in the Y-axis direction and outputs a Y-axis acceleration signal, and detects acceleration in a Z-axis direction and outputs a Z-axis acceleration signal.

The three-axis angular velocity sensor 12 includes an X-axis angular velocity sensor 21X, a Y-axis angular velocity sensor 21Y, and a Z-axis angular velocity sensor 21Z.

The X-axis angular velocity sensor 21X detects an angular velocity about the X-axis with the X-axis as a detection axis, and outputs an X-axis angular velocity signal corresponding to the detected angular velocity. The Y-axis angular velocity sensor 21Y detects an angular velocity about the Y-axis with the Y-axis as a detection axis, and outputs a Y-axis angular velocity signal corresponding to the detected angular velocity. The Z-axis angular velocity sensor 21Z detects an angular velocity about the Z-axis with the Z-axis as a detection axis, and outputs a Z-axis angular velocity signal corresponding to the detected angular velocity. In the present embodiment, the X-axis angular velocity sensor 21X, the Y-axis angular velocity sensor 21Y, and the Z-axis angular velocity sensor 21Z are MEMS gyroscopes such as a capacitive type or the like having sensor elements obtained by processing a silicon substrate by a MEMS technique.

For example, each of the X-axis angular velocity sensor 21X, the Y-axis angular velocity sensor 21Y, and the Z-axis angular velocity sensor 21Z outputs a digital signal of a value corresponding to an angular velocity detected at a constant sampling period Δt.

As described above, the three-axis angular velocity sensor 12 detects an angular velocity about the X-axis and outputs an X-axis angular velocity signal, detects an angular velocity about the Y-axis and outputs a Y-axis angular velocity signal, and detects an angular velocity about the Z-axis and outputs a Z-axis angular velocity signal.

The sensor module 1 includes digital filters 30X, 30Y, 30Z, 31X, 31Y, and 31Z and bias correction sections 40X, 40Y, 40Z, 41X, 41Y, and 41Z.

The digital filter 30X performs low-pass filter processing on the X-axis acceleration signal output from the X-axis accelerometer 20X, and reduces unnecessary signal components outside a band of the motion of the automobile 400. The digital filter 30Y performs low-pass filter processing on the Y-axis acceleration signal output from the Y-axis accelerometer 20Y, and reduces unnecessary signal components outside a band of the motion of the automobile 400. The digital filter 30Z performs low-pass filter processing on the Z-axis acceleration signal output from the Z-axis accelerometer 20Z, and reduces unnecessary signal components outside a band of the motion of the automobile 400.

The digital filter 31X performs low-pass filter processing on the X-axis angular velocity signal output from the X-axis angular velocity sensor 21X, and reduces unnecessary signal components outside a band of the motion of the automobile 400. The digital filter 31Y performs low-pass filter processing on the Y-axis angular velocity signal output from the Y-axis angular velocity sensor 21Y, and reduces unnecessary signal components outside a band of the motion of the automobile 400. The digital filter 31Z performs low-pass filter processing on the Z-axis angular velocity signal output from the Z-axis angular velocity sensor 21Z, and reduces unnecessary signal components outside a band of the motion of the automobile 400.

The bias correction section 40X calculates acceleration a_{X} in the X-axis direction by removing a bias, which is an error when the automobile 400 is stationary, from a signal output from the digital filter 30X. The bias correction section 40Y calculates acceleration a_{Y} in the Y-axis direction by removing the bias from the signal output from the digital filter 30Y. The bias correction section 40Z calculates acceleration a_{z} in the Z-axis direction by removing the bias from the signal output from the digital filter 30Z.

The bias correction section 41X calculates an angular velocity ωₓ about the X-axis by removing a bias, which is an error when the automobile 400 is stationary, from the signal output from the digital filter 31X. The bias correction section 41Y calculates an angular velocity ω_{y} about the Y-axis by removing the bias from the signal output from the digital filter 31Y. The bias correction section 41Z calculates an angular velocity ω_{z} about the Z-axis by removing the bias from the signal output from the digital filter 31Z.

As a method of removing the bias by the bias correction sections 40X, 40Y, 40Z, 41X, 41Y, and 41Z, for example, there are a method of correcting a bias by using an output mean value during a stationary state, a method of correcting the bias by integration with other measurement devices such as a GNSS or a LiDAR, a method of removing noise and biases of low-frequency components outside a band of motion of the automobile 400 by a high-pass filter, and the like.

The sensor module 1 includes a Z-axis angular velocity sensor 22Z, a digital filter 32Z, and a bias correction section 42Z.

The Z-axis angular velocity sensor 22Z detects an angular velocity about a Z′-axis with the Z′-axis corresponding to the Z-axis as a detection axis, and outputs a Z′-axis detection signal corresponding to the detected angular velocity. In the present embodiment, the Z-axis angular velocity sensor 22Z is a quartz crystal gyroscope that includes a sensor element made of quartz crystal and detects an angular velocity with high accuracy.

The digital filter 32Z performs low-pass filter processing on the Z′-axis angular velocity signal output from the Z-axis angular velocity sensor 22Z, and reduces unnecessary signal components outside a band of the motion of the automobile 400.

The bias correction section 42Z calculates an angular velocity Ω_{z} about the Z′-axis by removing the bias, which is an error when the automobile 400 is stationary, from the signal output from the digital filter 32Z.

The sensor module 1 includes a misalignment correction section 50 and an attitude/heading estimation section 60.

It is ideal that the Z-axis, which is a detection axis of the Z-axis angular velocity sensor 21Z, and the Z′-axis, which is a detection axis of the Z-axis angular velocity sensor 22Z, completely coincide with each other. However, in practice, since the 6DoF sensor 10 including the Z-axis angular velocity sensor 21Z and the Z-axis angular velocity sensor 22Z are separate from each other, an alignment error occurs due to deviation of the Z′-axis with respect to the Z-axis.

Based on a sensitivity ratio of the angular velocity ω_{z} about the Z-axis, the X-axis angular velocity signal, the Y-axis angular velocity signal, the Z-axis angular velocity signal, and the Z′-axis angular velocity signal, the misalignment correction section 50 corrects an alignment error, which is an error in the angular velocity Ω_{z} about the Z′-axis due to deviation of the Z′-axis with respect to the Z-axis. As will be described later, in the present embodiment, the misalignment correction section 50 estimates a coefficient related to the sensitivity ratio of the angular velocity Ω_{z} by a Kalman filter based on the angular velocities ωₓ, ω_{y}, ω_{z}, and Ω_{z}, and calculates the sensitivity ratio from the estimated coefficient. Then, the misalignment correction section 50 calculates an angular velocity Ω_{z}^{c} obtained by correcting the alignment error of the angular velocity Ω_{z} based on the calculated sensitivity ratio of the angular velocity ω_{z}.

The attitude/heading estimation section 60 estimates the roll angle Φ and the pitch angle Θ as the relative attitude of the sensor module 1 and estimates the yaw angle Ψ as the relative heading of the sensor module 1 by various known methods based on the heading Ψ_{gnss} output from the heading/velocity/position estimation section 120 and the acceleration aₓ, a_{y}, and a_{z}, and the angular velocities ωₓ, ω_{y}, and Ω_{z}^{c}. Since the sensor module 1 is fixed to the automobile 400, the relative attitude and the relative heading of the sensor module 1 correspond to the relative attitude and the relative heading of the automobile 400.

### 1-3. Processing of Misalignment Correction Section

In the present embodiment, it is assumed that the following conditions [1] to [3] are satisfied, the misalignment correction section 50 estimates a coefficient related to the sensitivity ratio of the angular velocity ω_{z} about the Z-axis by the Kalman filter, and corrects the alignment error of the angular velocity Ω_{z} based on the sensitivity ratio of the angular velocity ω_{z} calculated from the coefficient. [1] Reference axes for alignment are the X-axis, the Y-axis, and the Z-axis, which are detection axes of the 6DoF sensor 10. Since the three-axis angular velocity sensor 12, which is generally a MEMS gyroscope, is manufactured by photolithography, the X-axis, the Y-axis, and the Z-axis intersect one another at approximately 90°. [2] The Z-axis angular velocity sensor 22Z, which is a quartz crystal gyroscope, has a smaller sensitivity error than the three-axis angular velocity sensor 12, which is a MEMS gyroscope. [3] The automobile 400 on which the sensor module 1 is mounted is in motion.

When a true value of the angular velocity about the X-axis is defined as ω_{x,in}, a true value of the angular velocity about the Y-axis is defined as ω_{y,in}, a true value of the angular velocity about the Z-axis is defined as ω_{z,in}, the sensitivity ratio of the angular velocity ωₓ is defined as Sₓ⁻¹, the sensitivity ratio of the angular velocity ω_{y} is defined as S_{y}⁻¹, and the sensitivity ratio of the angular velocity ω_{z} is defined as S_{z}⁻¹, the angular velocities ωₓ, ω_{y}, and ω_{z} are expressed by Equation (1). The sensitivity ratios Sₓ⁻¹, S_{y}⁻¹, S_{z}⁻¹ are ideally 1, but may actually be greater than 1 or less than 1.

$$[ \begin{matrix}{ω}_{x} \\ {ω}_{y} \\ {ω}_{z}\end{matrix} ] = {[ \begin{matrix}{S}_{x} & 0 & 0 \\ 0 & {S}_{y} & 0 \\ 0 & 0 & {S}_{z}\end{matrix} ]}^{- 1} [ \begin{matrix}{ω}_{x , in} \\ {ω}_{y , in} \\ {ω}_{z , in}\end{matrix} ] = [ \begin{matrix}{S}_{x}^{- 1} & 0 & 0 \\ 0 & {S}_{y}^{- 1} & 0 \\ 0 & 0 & {S}_{z}^{- 1}\end{matrix} ] [ \begin{matrix}{ω}_{x , in} \\ {ω}_{y , in} \\ {ω}_{z , in}\end{matrix} ] \qquad ( 1 )$$

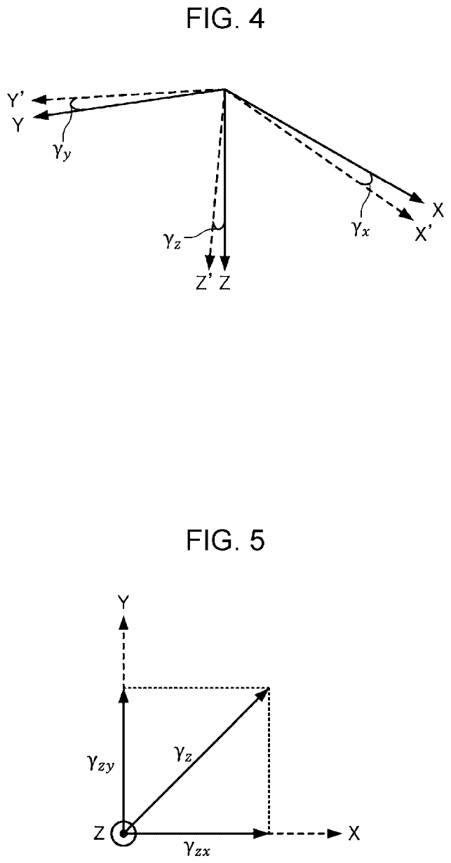

Similarly to the Z′-axis corresponding to the Z-axis, X′-axis corresponding to the X-axis and Y′-axis corresponding to the Y-axis are assumed, and, as illustrated in FIG. 4, an angle between the X-axis and the X′-axis is defined as γₓ, an angle between the Y-axis and the Y′-axis is defined as γ_{y}, and an angle between the Z-axis and the Z′-axis is defined as γ_{z}. When the angle γ_{z} corresponding to the misalignment of the Z′-axis with respect to the Z-axis is sufficiently small, as illustrated in FIG. 5, the angle γ_{z} is decomposed into an angle γ_{zx} corresponding to the misalignment of the Z′-axis in the X-axis direction and an angle γ_{zy} corresponding to the misalignment of the Z′-axis in the Y-axis direction. Therefore, a relational expression (2) between the angle γ_{z} and the angles γ_{zx} and γ_{zy} is obtained.

$${γ}_{x}^{2} = {y}_{zx}^{2} + {γ}_{zy}^{2} \qquad ( 2 )$$

Similarly, the angle γₓ corresponding to the misalignment of the X′-axis with respect to the X-axis is decomposed into an angle γ_{xy} corresponding to the misalignment of the X′-axis in the Y-axis direction and an angle γ_{xz} corresponding to the misalignment of the X′-axis in the Z-axis direction. Similarly, the angle γ_{y} corresponding to the misalignment of the Y′-axis with respect to the Y-axis is decomposed into an angle γ_{yx} corresponding to the misalignment of the Y′-axis in the X-axis direction and an angle γ_{yz} corresponding to the misalignment of the Y′-axis in the Z-axis direction.

Therefore, a relationship between the angular velocities Ωₓ, Ω_{y}, and Ω_{z} and the true values ω_{x,in}, ω_{y,in}, and ω_{z,in} of the angular velocities is expressed by Equation (3). In Equation (3), the sensitivity ratio of the angular velocity Ω_{z} is set to 1 based on the above-described condition [2]. In addition, since the angular velocity sensor for detecting the X′-axis and the angular velocity sensor for detecting the Y′-axis do not actually exist, the sensitivity ratios of the angular velocities Ωₓ and Ω_{y} are 0, and the angular velocities Ω_{y} and Ω_{z} are also 0.

$$[ \begin{matrix}{Ω}_{x} \\ {Ω}_{y} \\ {Ω}_{z}\end{matrix} ] = [ \begin{matrix}0 \\ 0 \\ Ω\end{matrix} ] = [ \begin{matrix}0 & 0 & 0 \\ 0 & 0 & 0 \\ 0 & 0 & 1\end{matrix} ] [ \begin{matrix}cos {γ}_{x} & sin {γ}_{xy} & sin {γ}_{xz} \\ sin {γ}_{yx} & cos {γ}_{y} & sin {γ}_{yz} \\ sin {γ}_{zx} & sin {γ}_{zy} & cos {γ}_{z}\end{matrix} ] [ \begin{matrix}{ω}_{x , in} \\ {ω}_{y , in} \\ {ω}_{z , in}\end{matrix} ] \qquad ( 3 )$$

Equation (4) is derived from Equation (1) and Equation (3).

$$[ \begin{matrix}0 \\ 0 \\ {Ω}_{z}\end{matrix} ] = [ \begin{matrix}0 & 0 & 0 \\ 0 & 0 & 0 \\ 0 & 0 & 1\end{matrix} ] [ \begin{matrix}cos {γ}_{x} & sin {γ}_{xy} & sin {γ}_{xz} \\ sin {γ}_{yx} & cos {γ}_{y} & sin {γ}_{yz} \\ sin {γ}_{zx} & sin {γ}_{zy} & cos {γ}_{z}\end{matrix} ] [ \begin{matrix}{S}_{x} & 0 & 0 \\ 0 & {S}_{y} & 0 \\ 0 & 0 & {S}_{z}\end{matrix} ] [ \begin{matrix}{ω}_{x} \\ {ω}_{y} \\ {ω}_{z}\end{matrix} ] \qquad ( 4 )$$

Equation (4) is expanded and Equation (5) is derived. In Equation (5), a coefficient a₁=Sₓ·sin γ_{zx}, a coefficient a₂=S_{y}·sin γ_{zy}, and a₃=S_{z}·cos γ_{z}.

$${Ω}_{z} = {ω}_{x} \cdot {S}_{x} sin {γ}_{zx} + {ω}_{y} \cdot {S}_{y} sin {γ}_{zy} + {ω}_{z} \cdot {S}_{z} cos {γ}_{z} = {a}_{1} {ω}_{x} + {a}_{2} {ω}_{y} + {a}_{3} {ω}_{z} \qquad ( 5 )$$

Equation (6) is derived from Equation (1).

$${ω}_{z , in} = {S}_{z} {ω}_{z} \qquad ( 6 )$$

Equation (7) is derived from Equation (5) and Equation (6).

$${ω}_{z , in} = {S}_{z} {ω}_{z} = \frac{1}{cos {γ}_{z}} ( {Ω}_{z} - {a}_{1} {ω}_{x} - {a}_{2} {ω}_{y} ) = {Ω}_{z}^{c} \qquad ( 7 )$$

In the present embodiment, the misalignment correction section 50 estimates the coefficients a_{1,k}, a_{2,k}, and a₃,k by a Kalman filter. Therefore, as illustrated in Equation (8), a state variable xₖ having the coefficients a₁, a₂, and a₃ as elements is defined.

$${x}_{k} = {[ \begin{matrix}{a}_{1 , k} & {a}_{2 , k} & {a}_{3 , k}\end{matrix} ]}^{T} \qquad ( 8 )$$

The state equation is defined by Equation (9). In Equation (9), Fₖ is a state transition matrix and as illustrated in Equation (10), is assumed to be a 3×3 identity matrix. In addition, in Equation (9), vₖ is system noise, and as illustrated in Equation (11), σᵥ₁, σᵥ₂, and σᵥ₃ set to appropriate values in advance are elements. σᵥ₁, σᵥ₂, and σᵥ₃ are set to finite values of 0 or more based on the sensitivity characteristics of the Z-axis angular velocity sensor 21Z, the alignment accuracy at the time of mounting, the temperature characteristics, and the like.

$${x}_{k} = {F}_{k} {x}_{k - 1} + {v}_{k} \qquad ( 9 )$$

$${F}_{k} = I = [ \begin{matrix}1 & 0 & 0 \\ 0 & 1 & 0 \\ 0 & 0 & 1\end{matrix} ] \qquad ( 10 )$$

$${v}_{k} = {[ \begin{matrix}{σ}_{v 1} & {σ}_{v 2} & {σ}_{v 3}\end{matrix} ]}^{T} \qquad ( 11 )$$

In the present embodiment, as illustrated in Equation (12), the angular velocity Ω_{z,k} about the Z′-axis is set as an observation variable yₖ.

$${y}_{k} = {Ω}_{z , k} \qquad ( 12 )$$

The observation equation is defined by Equation (13). In Equation (13), Hₖ is an observation matrix, and is expressed by Equation (14). In addition, in Equation (13), wₖ is observation noise and is set to an appropriate value σ_{w} in advance as illustrated in Equation (15). As σ_{w}, a finite value of 0 or more is set based on the noise characteristics of the Z-axis angular velocity sensor 22Z.

$${y}_{k} = {H}_{k} {x}_{k} + {w}_{k} \qquad ( 13 )$$

$${H}_{k} = [ \begin{matrix}{ω}_{x , k} & {ω}_{y , k} & {ω}_{z , k}\end{matrix} ] \qquad ( 14 )$$

$${w}_{k} = {σ}_{w} \qquad ( 15 )$$

The misalignment correction section 50 executes a prediction step, an observation step, and an update step of the Kalman filter to estimate the coefficients a_{1,k}, a_{2,k}, and a_{3,k}.

First, in the prediction step, the misalignment correction section 50 predicts a state variable x\hat{ }_{k|k-1} at the time k from a state variable x\hat{ }_{k-1|k-1} updated in the update step at the time k−1 by Equation (16) based on the state equation (9). That is, the state variable x\hat{ }_{k-1|k-1} is a posterior estimation value at the time k−1, and the state variable x\hat{ }_{k|k-1} is a priori estimation value at the time k.

$${\hat{x}}_{k \vert k - 1} = {F}_{k} {\hat{x}}_{k - 1 \vert k - 1} = {\hat{x}}_{k - 1 \vert k - 1} \qquad ( 16 )$$

In addition, in the prediction step, the misalignment correction section 50 predicts a covariance matrix P_{k|k-1} of the state variable x\hat{ }_{k|k-1} at the time k from a covariance matrix P_{k-1|k-1} of the state variable x\hat{ }_{k-1|k-1} updated in the update step at the time k−1 using Equation (17). In Equation (17), Vₖ is the covariance matrix of the system noise vₖ, which is calculated by Equation (18).

$${P}_{k \vert k - 1} = {F}_{k} {P}_{k - 1 \vert k - 1} {F}_{k}^{T} + {V}_{k} = {P}_{k - 1 \vert k - 1} + {V}_{k} \qquad ( 17 )$$

$${V}_{k} = [ \begin{matrix}{σ}_{v 1}^{2} & 0 & 0 \\ 0 & {σ}_{v 2}^{2} & 0 \\ 0 & 0 & {σ}_{v 3}^{2}\end{matrix} ] \qquad ( 18 )$$

Next, in the observation step, the misalignment correction section 50 calculates a value to be observed from the state variable x\hat{ }_{k|k-1} predicted in the prediction step at the time k by Equation (19) based on the observation equation (13).

$${H}_{k} {\hat{x}}_{k \vert k - 1} = {\hat{a}}_{1 , k \vert k - 1} {ω}_{x , k} + {\hat{a}}_{2 , k \vert k - 1} {ω}_{y , k} + {\hat{a}}_{3 , k \vert k - 1} {ω}_{z , k} \qquad ( 19 )$$

Then, the misalignment correction section 50 calculates an observation residual eₖ, which is a difference between the value of the observation variable yₖ at the time k actually observed and the value calculated by Equation (19), by Equation (20).

$${e}_{k} = {y}_{k} - {H}_{k} {\hat{x}}_{k \vert k - 1} \qquad ( 20 )$$

Further, in the observation step, the misalignment correction section 50 calculates the covariance matrix Sₖ of the observation residual eₖ from the covariance matrix P_{k|k-1} of the state variable x\hat{ }_{k|k-1} predicted in the prediction step at the time k by Equation (21). In Equation (21), Wₖ is the covariance matrix of the observation noise wₖ, which is calculated by Equation (22).

$${S}_{k} = {W}_{k} + {H}_{k} {P}_{k \vert k - 1} {H}_{k}^{T} \qquad ( 21 )$$

$${W}_{k} = {σ}_{w}^{2} \qquad ( 22 )$$

Finally, in the update step, the misalignment correction section 50 calculates the Kalman gain Kₖ by Equation (23) from the covariance matrix P_{k|k-1} of the state variable x\hat{ }_{k|k-1} predicted in the prediction step at the time k and the covariance matrix Sₖ of the observation residual eₖ calculated in the observation step at the time k.

$${K}_{k} = {P}_{k \vert k - 1} {H}_{k}^{T} {S}_{k}^{- 1} \qquad ( 23 )$$

Then, in the update step, the misalignment correction section 50 updates the state variable x\hat{ }_{k|k-1} predicted in the prediction step at the time k to the state variable x\hat{ }_{k|k} based on the Kalman gain Kₖ and the observation residual eₖ calculated in the observation step at the time k by Equation (24). As described above, the state variable x\hat{ }_{k|k-1} is a priori estimation value at the time k. The state variable x\hat{ }_{k|k} is a posterior estimation value at the time k.

$${\hat{x}}_{k \vert k} = {\hat{x}}_{k \vert k - 1} + {K}_{k} {e}_{k} \qquad ( 24 )$$

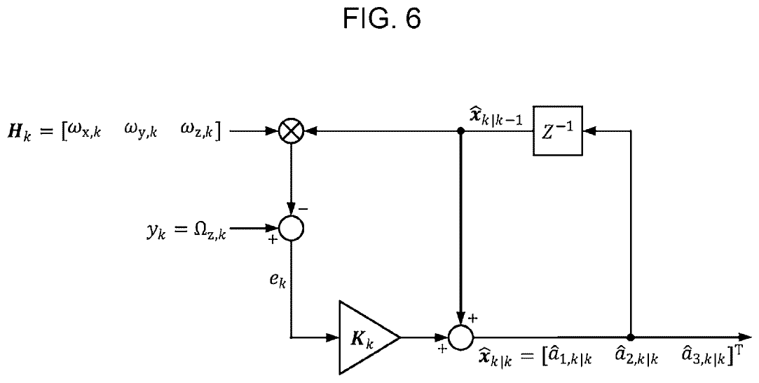

As described above, the misalignment correction section 50 estimates the coefficients a_{1,k}, a_{2,k}, and a_{3,k} included in the state variable xₖ using the Kalman filter. FIG. 6 illustrates a calculation block diagram of the Kalman filter according to the equations (8) to (24).

In addition, in the update step, the misalignment correction section 50 updates the covariance matrix P_{k|k-1} of the state variable x\hat{ }_{k|k-1} predicted in the prediction step at the time k to the covariance matrix P_{k|k} of the state variable x\hat{ }_{k|k} based on the Kalman gain Kₖ by Equation (25).

$${P}_{k \vert k} = [ \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ] = ( I - {K}_{k} {H}_{k} ) {P}_{k \vert k - 1} \qquad ( 25 )$$

In the covariance matrix P_{k|k}, p₁₁ is the variance of the coefficient a_{1,k}, p₂₂ is the variance of the coefficient a_{2,k}, and p₃₃ is the variance of the coefficient a_{3,k}.

Then, the misalignment correction section 50 calculates an angle γ_{zx,k} corresponding to the misalignment of the Z′-axis in the X-axis direction and an angle γ_{zy,k} corresponding to the misalignment the Z′-axis in the Y-axis direction from the coefficients a₁ and a₂ estimated by the Kalman filter by Equation (26) and Equation (27).

$${γ}_{zx , k} = {sin}^{- 1} \frac{{a}_{1 , k}}{{S}_{x , k}} ≅ {sin}^{- 1} {a}_{1 , k} \qquad ( 26 )$$

$${γ}_{zy , k} = {sin}^{- 1} \frac{{a}_{2 , k}}{{S}_{y , k}} ≅ {sin}^{- 1} {a}_{2 , k} \qquad ( 27 )$$

In addition, the misalignment correction section 50 calculates an absolute value of the angle γ_{z} corresponding to the misalignment of the Z′-axis with respect to the Z-axis by Equation (28).

$$\vert {γ}_{z , k} \vert = \sqrt{{γ}_{zx , k}^{2} + {γ}_{zy , k}^{2}} \qquad ( 28 )$$

Further, the misalignment correction section 50 calculates a reciprocal of the sensitivity ratio Sₓ⁻¹ by Equation (29). It is a cos γ_{z,k}>0 because of |γ_{z,k}|<90°.

$${S}_{z , k} = \frac{{a}_{3 , k}}{cos {γ}_{z , k}} \qquad ( 29 )$$

Then, the misalignment correction section 50 calculates the angular velocity Ω_{z}^{c} obtained by correcting the alignment errors of the angular velocity Ω_{z} by the above-described Equation (7) and Equation (29).

The three-axis angular velocity sensor 12 is an example of a “first angular velocity sensor”, and the Z-axis angular velocity sensor 22Z is an example of a “second angular velocity sensor”. The X-axis is an example of a “first axis”, the Y-axis is an example of a “second axis”, the Z-axis is an example of a “third axis”, and the Z′-axis is an example of a “fourth axis”. The X-axis angular velocity signal is an example of a “first angular velocity signal”, the Y-axis angular velocity signal is an example of a “second angular velocity signal”, the Z-axis angular velocity signal is an example of a “third angular velocity signal”, and the Z′-axis angular velocity signal is an example of a “fourth angular velocity signal”. The misalignment correction section 50 is an example of a “correction circuit”.

### 1-4. Operational Effects

As described above, in the sensor module 1 of the first embodiment, since the coefficient a₃ related to the sensitivity ratio S_{z}⁻¹ of the angular velocity ω_{z} about the Z-axis can be accurately estimated by the Kalman filter, the sensitivity ratio S_{z}⁻¹ can be calculated from the coefficient a₃ with high accuracy. Therefore, according to the sensor module 1 of the first embodiment, in addition to the angular velocity ωₓ about the X-axis, the angular velocity ω_{y} about the Y-axis, the angular velocity ω_{z} about the Z-axis, and the angular velocity Ω_{z} about the Z′-axis, a sensitivity ratio S_{z}⁻¹ of the angular velocity ω_{z} about the Z-axis is also taken into account, an error in the angular velocity Ω_{z} about the Z′-axis, which occurs due to misalignment of the Z-axis angular velocity sensor 22Z with respect to the three-axis angular velocity sensor 12 can be accurately corrected.

### 2. Second Embodiment

In the following, for a second embodiment, components similar to those in the first embodiment will be given the same symbols, and the descriptions that overlap with the first embodiment will be omitted or simplified, and the differences from the first embodiment will be mainly described.

For example, the sensor module 1 of the second embodiment is incorporated into the self-position estimation system 100 similarly to the first embodiment. Since the function and configuration of the sensor module 1 of the second embodiment are the same as those of FIG. 3, the illustration and description thereof will be omitted. In the sensor module 1 of the second embodiment, at least a part of processing of the misalignment correction section 50 is different from the first embodiment.

In the first embodiment, the misalignment correction section 50 calculates the angle γ_{zx} corresponding to the misalignment of the Z′-axis in the X-axis direction, the angle γ_{zy} corresponding to the misalignment of the Z′-axis in the Y-axis direction, and the sensitivity ratio S_{z}⁻¹ of the angular velocity ω_{z} by equations (26) to (29) based on the coefficients a₁ and a₂ estimated by the Kalman filter. On the other hand, in the second embodiment, the misalignment correction section 50 directly estimates the angle γ_{zx}, the angle γ_{zy} and the sensitivity ratio S_{z}⁻¹ by the Kalman filter.

Equation (30) is derived by substituting equations (26) to (28) into Equation (5), and Equation (31) is derived from Equation (30) and the above-described Equation (6).

$${Ω}_{z} ≅ {ω}_{x} \cdot sin {γ}_{zx} + {ω}_{y} \cdot sin {γ}_{zy} + {ω}_{z} \cdot {S}_{z} cos \sqrt{{γ}_{zx}^{2} + {γ}_{zy}^{2}} \qquad ( 30 )$$

$${ω}_{z , in} = {S}_{z} {ω}_{z} ≅ \frac{1}{cos \sqrt{{γ}_{zx}^{2} + {γ}_{zy}^{2}}} ( {Ω}_{z} - {ω}_{x} \cdot sin {γ}_{zx} - {ω}_{y} \cdot sin {γ}_{zy} ) = {Ω}_{z}^{c} \qquad ( 31 )$$

In the second embodiment, as illustrated in Equation (32), the state variable xₖ having the angle γ_{zx}, the angle γ_{zy}, and the reciprocal of the sensitivity ratio S_{z}⁻¹ as elements is defined.

$${x}_{k} = [ \begin{matrix}{γ}_{zx , k} & {γ}_{zy , k} & {{S}_{z , k} ]}^{T}\end{matrix} \qquad ( 32 )$$

Also in the second embodiment, the state equation is the same as the above-described Equation (9), and the angular velocity Ω_{z,k} about the Z′-axis is set as the observation variable yₖ as in the above-described Equation (12).

In the second embodiment, the observation equation is defined by Equation (33). In Equation (33), wₖ is observation noise, and is expressed by the above-described Equation (15).

$$\begin{matrix}{y}_{k} = h ( {x}_{k} , {w}_{k} ) \\ = {w}_{x , k} \cdot sin {γ}_{zx , k} + {ω}_{y , k} \cdot sin {γ}_{zy , k} + {ω}_{z , k} \cdot {S}_{z , k} cos \sqrt{{γ}_{zx , k}^{2} + {γ}_{zy , k}^{2}} + {w}_{k} \\ ≅ {H}_{k} {x}_{k} + {w}_{k}\end{matrix} \qquad ( 33 )$$

As illustrated in Equation (33), since the observation equation is nonlinear with respect to the state variable xₖ, it is necessary to introduce a nonlinear Kalman filter. The misalignment correction section 50 estimates the angles γ_{zx} and γ_{zy} and the sensitivity ratio S_{z}⁻¹ by using, for example, an extended Kalman filter that locally linearizes a nonlinear function and calculates covariances as a nonlinear Kalman filter. In Equation (33), Hₖ is the observation Jacobian and is expressed by Equation (34).

$${H}_{k} = \frac{dh}{dx} {\vert}_{x = {x}_{k}} = {[ \begin{matrix}{ω}_{x , k} \cdot cos {γ}_{zx , k} - {ω}_{z , k} \cdot {S}_{z , k} \cdot \frac{{γ}_{zx , k}}{\sqrt{{γ}_{zx , k}^{2} + {γ}_{zy , k}^{2}}} \cdot sin \sqrt{{γ}_{zx , k}^{2} + {γ}_{zy , k}^{2}} \\ {ω}_{y , k} \cdot cos {γ}_{zy , k} - {ω}_{z , k} \cdot {S}_{z , k} \cdot \frac{{γ}_{zy , k}}{\sqrt{{γ}_{zx , k}^{2} + {γ}_{zy , k}^{2}}} \cdot sin \sqrt{{γ}_{zx , k}^{2} + {γ}_{zy , k}^{2}} \\ {ω}_{z , k} \cdot cos \sqrt{{γ}_{zx , k}^{2} + {γ}_{zy , k}^{2}}\end{matrix} ]}^{T} \qquad ( 34 )$$

The misalignment correction section 50 executes a prediction step, an observation step, and an update step of the extended Kalman filter to estimate the angles γ_{zx,k} and γ_{zy,k} and the sensitivity ratio S_{z,k}⁻¹.

First, in the prediction step, the misalignment correction section 50 predicts the state variable x\hat{ }_{k|k-1} at the time k from the state variable x\hat{ }_{k-1|k-1} updated in the update step at the time k−1 according to the above-described Equation (16) based on the above-described Equation (9).

Further, in the prediction step, the misalignment correction section 50 predicts the covariance matrix P_{k|k-1} of the state variable x\hat{ }_{k|k-1} at the time k from the covariance matrix P_{k-1|k-1} of the state variable x\hat{ }_{k-1|k-1} updated in the update step at the time k−1 by the above-described Equation (17).

Next, in the observation step, the misalignment correction section 50 calculates a value to be observed from the state variable x\hat{ }_{k|k-1} predicted in the prediction step at the time k by Equation (35) based on the observation equation (33).

$$h ( {\hat{x}}_{k \vert k - 1} ) = {ω}_{x , k} \cdot sin {\hat{γ}}_{zx , k \vert k - 1} + {ω}_{y , k} \cdot sin {\hat{γ}}_{zy , k \vert k - 1} + {ω}_{z , k} \cdot {\hat{S}}_{z , k \vert k - 1} cos \sqrt{{\hat{γ}}_{zx , k \vert k - 1}^{2} + {\hat{γ}}_{zy , k \vert k - 1}^{2}} \qquad ( 35 )$$

Then, the misalignment correction section 50 calculates an observation residual eₖ, which is a difference between a value of the observation variable yₖ at the time k actually observed and a value calculated by Equation (35), by Equation (36).

$${e}_{k} = {y}_{k} - h ( {\hat{x}}_{k \vert k - 1} ) \qquad ( 36 )$$

In addition, in the observation step, the misalignment correction section 50 calculates the covariance matrix Sₖ of the observation residual eₖ from the covariance matrix P_{k|k-1} of the state variable x\hat{ }_{k|k-1} predicted in the prediction step at the time k by the above-described Equation (21).

Finally, in the update step, the misalignment correction section 50 calculates the Kalman gain Kₖ from the covariance matrix P_{k|k-1} of the state variable x\hat{ }_{k|k-1} predicted in the prediction step at the time k and the covariance matrix Sₖ of the observation residual eₖ calculated in the observation step at the time k according to the above-described Equation (23).

Then, in the update step, the misalignment correction section 50 updates the state variable x\hat{ }_{k|k-1} predicted in the prediction step at the time k to the state variable x\hat{ }_{k|k} based on the Kalman gain Kₖ and the observation residual eₖ calculated in the observation step at the time k according to the above-described Equation (24).

As described above, the misalignment correction section 50 estimates the angles γ_{zx,k} and γ_{zy,k} and the sensitivity ratio S_{z,k}⁻¹ included in the state variable xₖ using the extended Kalman filter.

Further, in the update step, the misalignment correction section 50 updates the covariance matrix P_{k|k-1} of the state variable x\hat{ }_{k|k-1} predicted in the prediction step at the time k to the covariance matrix P_{k|k} of the state variable x\hat{ }_{k|k} based on the Kalman gain Kₖ by the above-described Equation (25).

Then, the misalignment correction section 50 calculates the angular velocity Ω_{z}^{c} obtained by correcting the alignment error of the angular velocity Ω_{z} by the above-described Equation (31).

According to the sensor module 1 of the second embodiment described above, the same effects as those of the sensor module 1 of the first embodiment can be obtained. Further, according to the sensor module 1 of the second embodiment, the estimation accuracy may be improved by directly estimating the angles γ_{zx} and γ_{zy} and the sensitivity ratio S_{z}⁻¹ by the Kalman filter.

### 3. Third Embodiment

Hereinafter, in a third embodiment, components similar to those in the first embodiment or the second embodiment are denoted by the same reference numerals, descriptions overlapping those in the first embodiment or the second embodiment are omitted or simplified, and matters different from the first and second embodiments are mainly described.

For example, the sensor module 1 of the third embodiment is incorporated into the self-position estimation system 100, similarly to the first embodiment and the second embodiment. Since the function and configuration of the sensor module 1 of the third embodiment are the same as those of FIG. 3, the illustration and description thereof will be omitted. In the sensor module 1 of the third embodiment, at least a part of processing of the misalignment correction section 50 is different from the first embodiment and the second embodiment.

In the third embodiment, the misalignment correction section 50 estimates the angles γ_{zx} and γ_{zy} and the sensitivity ratio S_{z}⁻¹ as a Kalman filter observation equation by a Taylor-expanded approximation of trigonometric functions of the above-described Equation (30), which is a relational expression between the angular velocity Ω_{z} and the angular velocities ωₓ, ω_{y}, and ω_{z} in order to reduce the computational load of the Kalman filter.

For example, when a sin term of the above-described Equation (30) is Taylor-expanded and approximated to first order, Equation (37) is obtained, and Equation (38) is derived from Equation (37) and the above-described Equation (6).

$${Ω}_{z} ≅ {ω}_{x} \cdot {γ}_{zx} + {ω}_{y} \cdot {γ}_{zy} + {ω}_{z} \cdot {S}_{z} cos \sqrt{{γ}_{zx}^{2} + {γ}_{zy}^{2}} \qquad ( 37 )$$

$${ω}_{z , in} = {S}_{z} {ω}_{z} ≅ \frac{1}{cos \sqrt{{γ}_{zx}^{2} + {γ}_{zy}^{2}}} ( {Ω}_{z} - {ω}_{x} \cdot {γ}_{zx} - {ω}_{y} \cdot {γ}_{z y} ) = {Ω}_{z}^{c} \qquad ( 38 )$$

Further, when a cos term of Equation (37) is Taylor-expanded and approximated to zeroth order, Equation (39) is obtained, and Equation (40) is derived from Equation (39) and the above-described Equation (6).

$${Ω}_{z} ≅ {ω}_{x} \cdot {γ}_{zx} + {ω}_{y} \cdot {γ}_{zy} + {ω}_{z} \cdot {S}_{z} \qquad ( 39 )$$

$${ω}_{z , in} = {S}_{z} {ω}_{z} ≅ {Ω}_{z} - {ω}_{x} \cdot {γ}_{zx} - {ω}_{y} \cdot {γ}_{z y} = {Ω}_{z}^{c} \qquad ( 40 )$$

In the third embodiment, similarly to the second embodiment, the state variable xₖ having the angles γ_{zx} and γ_{zy} and the reciprocal of the sensitivity ratio S_{z}⁻¹ as elements is defined as in the above-described Equation (32). Further, also in the third embodiment, the state equation is the same as the above-described Equation (9), and the angular velocity Ω_{z,k} about the Z′-axis is set as the observation variable yₖ as in the above-described Equation (12).

For example, the misalignment correction section 50 may set the observation equation as Equation (41) based on Equation (37), and estimate the angles γ_{zx,k} and γ_{zy,k} and the sensitivity ratio S_{z,k}⁻¹ by a nonlinear Kalman filter such as an extended Kalman filter. In this case, the misalignment correction section 50 can calculate the angular velocity Ω_{z}^{c} obtained by correcting the alignment error of the angular velocity Ω_{z} by Equation (38).

$$\begin{matrix}{y}_{k} = h ( {x}_{k} , {w}_{k} ) \\ = {ω}_{x , k} \cdot {γ}_{zx , k} + {ω}_{y , k} \cdot {γ}_{zy , k} + {ω}_{z , k} \cdot {S}_{z , k} cos \sqrt{{γ}_{zx , k}^{2} + {γ}_{zy , k}^{2}} + {w}_{k} \\ ≅ {H}_{k} {x}_{k} + {w}_{k}\end{matrix} \qquad ( 41 )$$

Alternatively, the misalignment correction section 50 may set the observation equation as in Equation (42) based on Equation (39) and estimate the angles γ_{zx,k} and γ_{zy,k} and the sensitivity ratio S_{z,k}⁻¹ by a linear Kalman filter. In this case, the misalignment correction section 50 can calculate the angular velocity Q c obtained by correcting the alignment error of the angular velocity Ω_{z} by Equation (40).

$$\begin{matrix}{y}_{k} = {H}_{k} {x}_{k} + {w}_{k} \\ = {ω}_{x , k} \cdot {γ}_{zx , k} + {ω}_{y , k} \cdot {γ}_{zy , k} + {ω}_{z , k} \cdot {S}_{z , k} + {w}_{k}\end{matrix} \qquad ( 42 )$$

According to the sensor module 1 of the third embodiment described above, the same effects as those of the sensor module 1 of the second embodiment can be obtained. Further, according to the sensor module 1 of the third embodiment, by using a Taylor-expanded approximation of trigonometric functions as a Kalman filter observation equation, computational load decreases. As a result, a computation rate can also be increased, and the estimation accuracy may be improved.

### 4. Fourth Embodiment

Hereinafter, in a fourth embodiment, the same reference numerals are given to the same components as those in any of the first embodiment to the third embodiment, the description overlapping with any of the first embodiment to the third embodiment are omitted or simplified, and the content different from any of the first embodiment to the third embodiment are mainly described.

For example, the sensor module 1 of the fourth embodiment is incorporated into the self-position estimation system 100 similarly to the first embodiment to the third embodiment. Since the function and configuration of the sensor module 1 of the fourth embodiment are the same as those of FIG. 3, the illustration and description thereof will be omitted. In the sensor module 1 of the fourth embodiment, at least a part of the processing of the misalignment correction section 50 is different from the first embodiment to the third embodiment.

Although noise of unnecessary high-frequency components can be removed by the digital filters 31X, 31Y, 31Z, and 32Z, it is difficult to appropriately set parameters such as cut-off frequencies and orders of the digital filters 31X, 31Y, 31Z, and 32Z in advance when the band of the motion of the automobile 400 cannot be predicted. Therefore, in the fourth embodiment, the misalignment correction section 50 estimates the angles γ_{zx} and γ_{zy} and the sensitivity ratio S_{z}⁻¹ by using, as a Kalman filter observation equation, a relational expression between the angle ΨZ obtained by integrating the angular velocity Ω_{z} about the Z′-axis, the angle θ_{X} obtained by integrating the angular velocity ω_{X} about the X-axis, the angle Θ_{y} obtained by integrating the angular velocity ω_{y} about the Y-axis, and the angle θ_{z} obtained by integrating the angular velocity ω_{z} about the Z-axis. By integrating the angular velocities Ω_{z}, Ωₓ, Ω_{y}, and Ω_{z}, noise of unnecessary high-frequency components decreases.

For example, when the above-described Equation (5) is integrated with respect to time, Equation (43) is obtained.

$$\int {Ω}_{z} dt = \int ( {ω}_{x} \cdot {S}_{x} sin {γ}_{zx} ) dt + \int ( {ω}_{y} \cdot {S}_{y} sin {γ}_{zy} ) dt + \int ( {ω}_{z} \cdot {S}_{z} sin {γ}_{z} ) dt \qquad ( 43 )$$

After the 6DoF sensor 10 and the Z-axis angular velocity sensor 22Z are mounted, the misalignment and the time-series variation of the sensitivity ratio may be small. When it is assumed that these are time-invariant, Equation (44) is obtained from Equation (43).

$$\begin{matrix}\int {Ω}_{z} dt = {S}_{x} sin {γ}_{zx} \int {ω}_{x} dt + {S}_{y} sin {γ}_{zy} \int {ω}_{y} dt + {S}_{z} cos {γ}_{z} \int {ω}_{z} dt \\ = {a}_{1} \int {ω}_{x} dt + {a}_{2} \int {ω}_{y} dt + {a}_{3} \int {ω}_{z} dt\end{matrix} \qquad ( 44 )$$

In Equation (44), when each integral is discretized as in Equation (45) and substituted into Equation (44), Equation (46) is obtained.

$$\int {Ω}_{z} dt = {Ψ}_{z , t} = {Ω}_{z , t} Δ t + {Ψ}_{z , k - 1} \qquad ( 45 )$$

$$\int {ω}_{x} dt = {θ}_{x , t} = {ω}_{x , t} Δ t + {θ}_{x , k - 1}$$

$$\int {ω}_{y} dt = {θ}_{y , t} = {ω}_{y , t} Δ t + {θ}_{y , k - 1}$$

$$\int {ω}_{z} dt = {θ}_{z , t} = {ω}_{z , t} Δ t + {θ}_{z , k - 1}$$

$$\begin{matrix}{Ψ}_{z , t} = {S}_{x} sin {γ}_{zx} {θ}_{x , k} + {S}_{y} sin {γ}_{zy} {θ}_{t , k} dt + {S}_{z} sin {γ}_{z} {θ}_{z , k} \\ = {a}_{1} {θ}_{x , k} + {a}_{2} {θ}_{y , k} + {a}_{3} {θ}_{z , k}\end{matrix} \qquad ( 46 )$$

In the fourth embodiment, for example, the state variable xₖ having the coefficients a₁, a₂, and a₃ as elements is defined as illustrated in the above-described Equation (8), and the state equation is the same as the above-described Equation (9). Further, as illustrated in Equation (47), an angle Ψ_{z,k} obtained by integrating the angular velocity Ω_{z,k} about the Z′-axis is set as the observation variable yₖ.

$${y}_{k} = {Ψ}_{z , k} \qquad ( 47 )$$

The observation equation is defined by the above-described Equation (13), and the observation matrix Hₖ is expressed by Equation (48).

$${H}_{k} = [ {θ}_{x , k} {θ}_{y , k} {θ}_{z , k} ] \qquad ( 48 )$$

The misalignment correction section 50 executes the prediction step, the observation step, and the update step of the Kalman filter and estimates the coefficients a_{1,k}, a_{2,k}, and a_{3,k} in the same manner as Equations (16) to (25). Then, the misalignment correction section 50 calculates the angular velocity Ω_{z}^{c} obtained by correcting the alignment error of the angular velocity Ω_{z} from the estimated coefficients a₁, a₂, and a₃ by the above-described Equation (7) and Equations (26) to (29).

Since integration errors accumulate when the angular velocities Ω_{z}, Ωₓ, Ω_{y}, and Ω_{z} are integrated for a long time, the misalignment correction section 50 may reset the integral values to zero as appropriate. That is, the misalignment correction section 50 may set an integral value up to a previous time to zero as in Equation (49) at any time.

$${Ψ}_{z , k - 1} = {θ}_{x , k - 1} = {θ}_{y , k - 1} = {θ}_{z , k - 1} = 0 \qquad ( 49 )$$

According to the sensor module 1 of the fourth embodiment described above, the same effects as those of the sensor module 1 of the first embodiment can be obtained. Further, according to the sensor module 1 of the fourth embodiment, since noise of high-frequency components decreases by integrating the angular velocities Ω_{z}, ωₓ, ω_{y}, and ω_{z}, the estimation accuracy may be improved.

### 5. Fifth Embodiment

Hereinafter, in a fifth embodiment, the same reference numerals are given to the same components as those in any of the first embodiment to the fourth embodiment, the description overlapping with any of the first embodiment to the fourth embodiment are omitted or simplified, and the content different from any of the first embodiment to the fourth embodiment are mainly described.

For example, the sensor module 1 of the fifth embodiment is incorporated into the self-position estimation system 100 similarly to the first embodiment to the fourth embodiment. Since the function and configuration of the sensor module 1 of the fifth embodiment are the same as those of FIG. 3, the illustration and description thereof will be omitted. In the sensor module 1 of the fifth embodiment, at least a part of the processing of the misalignment correction section 50 is different from the first embodiment to the fourth embodiment.

After the 6DoF sensor 10 and the Z-axis angular velocity sensor 22Z are mounted, the misalignment and the time-series variation of the sensitivity ratio may be small. Therefore, in the fifth embodiment, the misalignment correction section 50 applies a Kalman filter on an assumption that the alignment error of the angular velocity Ω_{z} and the sensitivity ratio S_{z}⁻¹ of the angular velocity ω_{z} are constant with respect to time. For example, when it can be assumed that the alignment error of the angular velocity Ω_{z} and the sensitivity ratio S_{z}⁻¹ of the angular velocity ω_{z}are time-invariant, the misalignment correction section 50 may set the system noise vₖ of the Kalman filter illustrated in the above-described Equation (11) to zero, as illustrated in Equation (50).

$${v}_{k} = {[ {σ}_{v 1} {σ}_{v 2} {σ}_{v 3} ]}^{T} = {[ 000 ]}^{T} \qquad ( 50 )$$

Then, the misalignment correction section 50 applies the same Kalman filter as that in any one of the first embodiment to the fourth embodiment, and calculates the angular velocity Ω_{z}^{c} obtained by correcting the alignment error of the angular velocity Ω_{z}.

According to the sensor module 1 of the fifth embodiment described above, the same effects as those of the sensor module 1 of any one of the first embodiment to the fourth embodiment can be obtained. Further, according to the sensor module 1 of the fifth embodiment, by applying the Kalman filter on the assumption that the alignment error of the angular velocity Ω_{z} and the sensitivity ratio S_{z}⁻¹ of the angular velocity ω_{z} are constant with respect to time, computation conditions can be made close to actual conditions, and estimation accuracy may be improved.

### 6. Sixth Embodiment

Hereinafter, in a sixth embodiment, the same reference numerals are given to the same components as those in any of the first embodiment to the fifth embodiment, the description overlapping with any of the first embodiment to the fifth embodiment are omitted or simplified, and the content different from any of the first embodiment to the fifth embodiment are mainly described.

For example, the sensor module 1 of the sixth embodiment is incorporated into the self-position estimation system 100 similarly to the first embodiment to the fifth embodiment. Since the function and configuration of the sensor module 1 of the sixth embodiment are the same as those of FIG. 3, the illustration and description thereof will be omitted. In the sensor module 1 of the sixth embodiment, at least a part of the processing of the misalignment correction section 50 is different from the first embodiment to the fifth embodiment.

In the first embodiment to the fifth embodiment, when all of the detected angular velocities ωₓ, ω_{y}, and ω_{z} are small, there is a possibility that the correction accuracy of the alignment error of the angular velocity Ω_{z} by the misalignment correction section 50 may decrease. Therefore, in the sixth embodiment, the misalignment correction section 50 corrects the alignment error of the angular velocity Ω_{z} when at least one of the angular velocities ωₓ, ω_{y}, and ω_{z} satisfies a predetermined condition. For example, the misalignment correction section 50 may correct the alignment error of the angular velocity Ω_{z} with respect to a union A∪B∪C of sets A, B, and C illustrated in Equation (51). That is, the misalignment correction section 50 may apply the angular velocities ωₓ, ω_{y}, and ω_{z} to the Kalman filter and correct the alignment error of the angular velocity Ω_{z} when an absolute value of an angular velocity ωₓ is greater than a predetermined threshold value ω_{th,x}, an absolute value of an angular velocity ω_{y} is greater than a predetermined threshold value ω_{th,y}, or an absolute value of an angular velocity ω_{z} is greater than a predetermined threshold value ω_{th,z}.

$$A = \{ {ω}_{x} \vert \vert {ω}_{x} \vert > {ω}_{th , x} \} \qquad ( 51 )$$

$$B = \{ {ω}_{y} \vert \vert {ω}_{y} \vert > {ω}_{th , y} \}$$

$$C = \{ {ω}_{z} \vert \vert {ω}_{z} \vert > {ω}_{th , z} \}$$

According to the sensor module 1 of the sixth embodiment described above, the same effects as those of the sensor module 1 of any one of the first embodiment to the fifth embodiment can be obtained. Further, according to the sensor module 1 of the sixth embodiment, when at least one of the angular velocities ωₓ, ω_{y}, and ω_{z} satisfies a predetermined condition, by correcting the alignment error of the angular velocity Ω_{z}, the correction accuracy may be improved.

### 7. Seventh Embodiment

Hereinafter, in a seventh embodiment, the same reference numerals are given to the same components as those in any of the first embodiment to the sixth embodiment, the description overlapping with any of the first embodiment to the sixth embodiment are omitted or simplified, and the content different from any of the first embodiment to the sixth embodiment are mainly described.

For example, the sensor module 1 of the seventh embodiment is incorporated into the self-position estimation system 100 similarly to the first embodiment to the sixth embodiment. Since the function and configuration of the sensor module 1 of the seventh embodiment are the same as those of FIG. 3, the illustration and description thereof will be omitted. In the sensor module 1 of the seventh embodiment, at least a part of the processing of the misalignment correction section 50 is different from the first embodiment to the sixth embodiment.

Depending on the motion state of the automobile 400, the estimation accuracy by the Kalman filter may decrease or the estimation may become unstable. In order to avoid this, in the seventh embodiment, the misalignment correction section 50 updates respective elements of the state variable xₖ of any one of Kalman filters of the first embodiment to the sixth embodiment when the variance of the respective elements falls below a minimum value of the variance within a predetermined period, and corrects the alignment error of the angular velocity Ω_{z} based on the state variable xₖ. For example, when the Kalman filter of the first embodiment is applied, the misalignment correction section 50 updates the coefficient a_{1,k} included in the state variable xₖ when a variance p₁₁ of the coefficient a_{1,k} included in the covariance matrix P_{k|k} of the above-described Equation (25) falls below the minimum value of the variance p₁₁ in a predetermined period, updates the coefficient a_{2,k} included in the state variable xₖ when the variance p₂₂ of the coefficient a_{2,k} falls below the minimum value of the variance p₂₂ in a predetermined period, and updates the coefficient a_{3,k} included in the state variable xₖ when the variance p₃₃ of the coefficient a_{3,k} falls below the minimum value of the variance p₃₃ in a predetermined period. The variances p₁₁, p₂₂, and p₃₃ respectively serve as indicators of the reliabilities of the coefficients a_{1,k}, a_{2,k}, and a_{3,k}, and smaller values indicate higher reliabilities. Therefore, the misalignment correction section 50 can correct the alignment error of the angular velocity Ω_{z} by using the coefficients a_{1,k},a_{2,k}, and a_{3,k} having the highest reliability in the predetermined period.

If the predetermined period is too long, there is a possibility that, even when a change in the state of the sensor module 1 occurs due to time degradation or the like, the state variable xₖ is not updated and the current state is not reflected. Therefore, the predetermined period is set to a period in which a change in the state of the sensor module 1 hardly occurs, for example, one day.

According to the sensor module 1 of the seventh embodiment described above, the same effects as those of the sensor module 1 of any one of the first embodiment to the sixth embodiment can be obtained. Further, according to the sensor module 1 of the seventh embodiment, the correction accuracy may be improved by correcting the alignment error of the angular velocity Ω_{z} based on the state variable xₖ having high reliability.

### 8. Modifications

The present disclosure is not limited to the present embodiment, and various modifications can be made within the scope of the spirit of the present disclosure.

In each of the above-described embodiments, the misalignment correction section 50 corrects the alignment error related to the Z-axis angular velocity. However, the misalignment correction section 50 may correct the alignment errors related to at least one of the X-axis angular velocity, the Y-axis angular velocity, the Z-axis angular velocity, the X-axis acceleration, the Y-axis acceleration, and the Z-axis acceleration.

In addition, in each of the above-described embodiments, the self-position estimation system 100 of the automobile 400 is exemplified as a system using the sensor module 1, but the sensor module 1 may be used in other systems. Further, the sensor module 1 may be mounted on any moving object other than an automobile.

In addition, in each of the embodiments described above, an example in which the Z-axis angular velocity sensor 22Z having sensitivity errors smaller than those of the three-axis angular velocity sensor 12 is a quartz crystal gyroscope has been described, but the Z-axis angular velocity sensor 22Z may be an FOG sensor. FOG is an abbreviation for Fiber Optic Gyroscope.

The above-described embodiments and modifications are merely examples, and the present disclosure is not limited thereto. For example, the respective embodiments and the respective modifications can be combined as appropriate.

The present disclosure includes a configuration substantially the same as the configuration described in the embodiment, for example, a configuration having the same function, method, and result, or a configuration having the same object and effect. Further, the present disclosure includes configurations in which non-essential portions of the configurations described in the embodiment are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

The following contents are derived from the above-described embodiments and modifications.

One aspect of a sensor module includes: when three axes orthogonal to each other are defined as a first axis, a second axis, and a third axis, a first angular velocity sensor configured to detect an angular velocity about the first axis to output a first angular velocity signal, to detect an angular velocity about the second axis to output a second angular velocity signal, and to detect an angular velocity about the third axis to output a third angular velocity signal; a second angular velocity sensor configured to detect an angular velocity about a fourth axis corresponding to the third axis to output a fourth angular velocity signal; and a correction circuit configured to correct an alignment error, which is an error of the angular velocity about the fourth axis due to deviation of the fourth axis with respect to the third axis, based on a sensitivity ratio of the angular velocity about the third axis and the first angular velocity signal, the second angular velocity signal, the third angular velocity signal, and the fourth angular velocity signal.

According to the sensor module, it is possible to accurately correct an error of the angular velocity about the fourth axis caused by misalignment of the second angular velocity sensor with respect to the first angular velocity sensor in consideration of the sensitivity ratio of the angular velocity about the third axis together with the first angular velocity signal, the second angular velocity signal, the third angular velocity signal, and the fourth angular velocity signal.

In one aspect of the sensor module, the correction circuit may estimate a coefficient related to the sensitivity ratio by a Kalman filter and calculate the sensitivity ratio from the estimated coefficient.

According to the sensor module, since it is possible to accurately estimate the coefficient related to the sensitivity ratio of the angular velocity about the third axis by the Kalman filter, it is possible to calculate the sensitivity ratio of the angular velocity about the third axis from the coefficient with high accuracy.

In one aspect of the sensor module, the correction circuit may estimate the sensitivity ratio by a Kalman filter.

According to the sensor module, the estimation accuracy may be improved by directly estimating the sensitivity ratio by the Kalman filter.

In the aspect of the sensor module, the correction circuit may estimate the sensitivity ratio by using, as an observation equation of the Kalman filter, an approximation obtained by Taylor-expanding a trigonometric function of a relational expression between the angular velocity about the fourth axis and the angular velocity about the first axis, the angular velocity about the second axis, and the angular velocity about the third axis.

According to the sensor module, by using a Taylor-expanded approximation of trigonometric functions as a Kalman filter observation equation, computational load decreases. As a result, a computation rate can also be increased, and the estimation accuracy may be improved.

In one aspect of the sensor module, the correction circuit may estimate the sensitivity ratio by using, as an observation equation of a Kalman filter, a relational expression between an angle obtained by integrating the angular velocity about the fourth axis and an angle obtained by integrating the angular velocity about the first axis, an angle obtained by integrating the angular velocity about the second axis, and an angle obtained by integrating the angular velocity about the third axis.

According to the sensor module, since noise of high-frequency components decreases by integrating the angular velocities, the estimation accuracy may be improved.

In one aspect of the sensor module, the correction circuit may apply the Kalman filter on an assumption that the alignment error and the sensitivity ratio are constant with respect to time.

According to the sensor module, since computation conditions can be made close to actual conditions, the estimation accuracy may be improved.

In one aspect of the sensor module, the correction circuit may set system noise of the Kalman filter to zero.

According to the sensor module, since computation conditions can be made close to actual conditions, the estimation accuracy may be improved.

In the aspect of the sensor module, the correction circuit may correct the alignment error when at least one of the angular velocity about the first axis, the angular velocity about the second axis, and the angular velocity about the third axis satisfies a predetermined condition.

According to the sensor module, the correction accuracy may be improved by correcting the alignment error when the angular velocity satisfies a predetermined condition.

In the aspect of the sensor module, the correction circuit may update respective elements of a state variable of the Kalman filter when a variance of the respective elements falls below a minimum value of the variance within a predetermined period.

According to the sensor module, the correction accuracy may be improved by correcting the alignment error based on the state variable with high reliability.

What is claimed is:

1. A sensor module comprising:
when three axes orthogonal to each other are defined as a first axis, a second axis, and a third axis,
a first angular velocity sensor configured to detect an angular velocity about the first axis to output a first angular velocity signal, to detect an angular velocity about the second axis to output a second angular velocity signal, and to detect an angular velocity about the third axis to output a third angular velocity signal;
a second angular velocity sensor configured to detect an angular velocity about a fourth axis corresponding to the third axis to output a fourth angular velocity signal; and
a correction circuit configured to correct an alignment error, which is an error of the angular velocity about the fourth axis due to deviation of the fourth axis with respect to the third axis, based on a sensitivity ratio of the angular velocity about the third axis and the first angular velocity signal, the second angular velocity signal, the third angular velocity signal, and the fourth angular velocity signal.

2. The sensor module according to claim 1, wherein
the correction circuit
estimates a coefficient related to the sensitivity ratio by a Kalman filter and calculate the sensitivity ratio from the estimated coefficient.

3. The sensor module according to claim 1, wherein
the correction circuit
estimates the sensitivity ratio by a Kalman filter.

4. The sensor module according to claim 3, wherein
the correction circuit
estimates the sensitivity ratio by using, as an observation equation of the Kalman filter, an approximation obtained by Taylor-expanding a trigonometric function of a relational expression between the angular velocity about the fourth axis and the angular velocity about the first axis, the angular velocity about the second axis, and the angular velocity about the third axis.

5. The sensor module according to claim 1, wherein
the correction circuit
estimates the sensitivity ratio by using, as an observation equation of a Kalman filter, a relational expression between an angle obtained by integrating the angular velocity about the fourth axis and an angle obtained by integrating the angular velocity about the first axis, an angle obtained by integrating the angular velocity about the second axis, and an angle obtained by integrating the angular velocity about the third axis.

6. The sensor module according to claim 2, wherein
the correction circuit
applies the Kalman filter on an assumption that the alignment error and the sensitivity ratio are constant with respect to time.

7. The sensor module according to claim 6, wherein
the correction circuit
sets system noise of the Kalman filter to zero.

8. The sensor module according to claim 1, wherein
the correction circuit
corrects the alignment error when at least one of the angular velocity about the first axis, the angular velocity about the second axis, and the angular velocity about the third axis satisfies a predetermined condition.

9. The sensor module according to claim 2, wherein
the correction circuit
updates respective elements of a state variable of the Kalman filter when a variance of the respective elements falls below a minimum value of the variance within a predetermined period.
